(19) United States
(12) Patent Application Publication
(10) Pub. No.: US 2019/0335378 A1
(43) Pub. Date: Oct. 31, 2019

(54) ACCESS POINT CONNECTIVITY

(71) Applicant: Hewlett Packard Enterprise Development LP, Houston, TX (US)

(72) Inventors: Praveen Parangattil, Bangalore (IN); Tathagata Roy, Bangalore (IN)

(21) Appl. No.: 15/962,224

(22) Filed: Apr. 25, 2018

(51) Int. Cl. H04W 40/24; H04L 12/26; H04W 76/18; H04W 4/80; H04W 88/08

(52) U.S. Cl. CPC H04W 40/24; H04L 43/0811; H04W 84/12; H04W 4/80; H04W 88/08; H04W 76/18

(57) ABSTRACT

Example implementations relate to an access point for a wireless local area network (WLAN). In an example, an access point comprises a wireless communication apparatus to communicate with a wireless device to provide access to the network, and a management module to determine a loss of connectivity to the network by the access point, switch the first access point into a maintenance mode in response to determining the loss of connectivity to the network by the access point, and cause the wireless communication apparatus to broadcast a message in the WLAN indicating that the first access point is in the maintenance mode to cause a network device in a radio frequency (RF) neighborhood of the first access point to receive the message and report to a network management node of the WLAN that the first access point is in the maintenance mode.

### BACKGROUND

An access point may provide access to a network for wireless devices. A wireless device may communicate with the access point using a wireless technology, and the access point may communicate with the network using a wired or wireless technology. Access points in a network may be managed by a network management node. In some circumstances, the access point may be unable to communicate with the network. For example, the access point may lose power, or a fault may develop in a connection between the access point and the network.

### BRIEF DESCRIPTION OF DRAWINGS

Examples will now be described, by way of non-limiting example, with reference to the accompanying drawings, in which:

FIG. 1 is a simplified schematic of an example of an access point for a wireless local area network (WLAN);

FIG. 2 is a simplified schematic of an example of an access point for a network;

FIG. 3 is a flow chart of an example of a method, for example a method of providing WLAN connectivity; and

FIG. 4 is a simplified schematic of an example of a wireless device.

### DETAILED DESCRIPTION

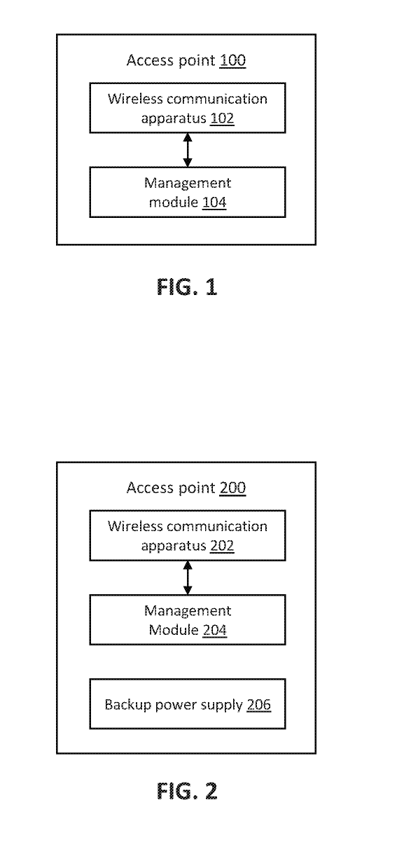

FIG. 1 is a simplified schematic of an example of a first access point 100 for a wireless local area network (WLAN). For example, the access point may enable access to the network by wireless devices. The access point 100 comprises wireless communication apparatus 102 to communicate with a wireless device (not shown) to provide access to the network (not shown). For example, the wireless device may communicate with the wireless communication apparatus 102 using any suitable wireless communication technology, such as Wi-Fi® or Bluetooth. The access point 100 may be connected to the network so that the wireless device may communicate wirelessly with the network via the access point 100. Therefore, for example, the wireless device may access resources in or through the network via the access point 100. In some examples, the access point 100 may be connected to the network using any suitable wireless or wired communication technology such as for example Wi-Fi, Bluetooth or Ethernet.

As used herein, a “network device” generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like. As used herein, an “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

The access point 100 also includes a management module 104 to determine a loss of connectivity to the network by the access point 100. For example, the management module 104 may determine that the connection between the access point 100 and the network is inoperable due to, for example, failure of hardware at the access point 100, failure of hardware at the other end of the connection (e.g. at a router, switch or other network node), failure of wiring associated with the connection (e.g. an Ethernet cable), loss of power supply at the access point 100 or any other reason. In some examples where there is loss of power at the access point 100, the access point may include a backup power supply such as a battery so that the management module 104 and/or the wireless communication apparatus 102 may still operate at least in part.

The management module 104 is also to switch the first access point into a maintenance mode in response to determining the loss of connectivity to the network by the access point 100, and cause the wireless communication apparatus 102 to broadcast a message in the WLAN indicating that the first access point 100 is in the maintenance mode to cause a network device in a radio frequency (RF) neighborhood of the first access point to receive the message and report to a network management node of the WLAN that the first access point 100 is in the maintenance mode. Therefore, for example, the network management node of the WLAN may still receive a report that the access point 100 is in the maintenance mode, even though the access point 100 may for example not be able to send a message directly to the network management node through the network.

In some examples, the same apparatus (the wireless communication apparatus 102) may be used to both communicate with the wireless device and to broadcast the message. In some examples, the same wireless technology may be used for both. For example, the wireless device may communicate with the wireless communication apparatus 102 using Wi-Fi, and the wireless communication apparatus 102 may broadcast the message using Wi-Fi. In some examples, the network device may be a second access point or a wireless device.

In some examples, the message may indicate details regarding the loss of connection, such as for example hardware failure, communication failure (e.g. due to cable failure or hardware failure in another node or device), or loss of power supply. In some examples, the message comprises or indicates at least one of an Ethernet status, a virtual private network status, a radio status, an Internet reachability status, a cellular signal status, and a specific error message. The message may therefore for example provide details relating to one or more functions of the access point 100

In some examples, in the event of loss of connectivity, the controller 104 may cause the wireless communication apparatus 102 to broadcast the message periodically. This may in some examples increase the likelihood that the message is received by another node or device.

In some examples, the wireless communication apparatus 102 may transmit the message to another device. The other device may be for example a wireless device, another access point for the network, or any other suitable device. The other device may include a connection so that it may for example report to the network management node by forwarding the message to the network management node.

In some examples, the network management node, upon receiving the report from the network device, may then take some action in relation to the loss of connectivity, such as for example creating an alert or an alarm, performing a repair on the connection, informing a network manager or any other action. The report may in some examples include information that may allow the network management node to diagnose the reason for the loss of connectivity and in some examples the network management node may take appropriate action to resolve the loss of connectivity.

FIG. 2 is a simplified schematic of an example of an access point 200 for a WLAN. The access point comprises wireless communication apparatus 202 to communicate with a wireless device to provide access to the network, and a management module 204 to determine a loss of connectivity to the network by the access point, switch the first access point into a maintenance mode in response to determining the loss of connectivity to the network by the access point, and cause the wireless communication apparatus to broadcast a message in the WLAN indicating that the first access point is in the maintenance mode to cause a network device in a radio frequency (RF) neighborhood of the first access point to receive the message and report to a network management node of the WLAN that the first access point is in the maintenance mode. In some examples, the wireless communication apparatus 202 and/or the management module 204 are similar or identical to the wireless communication apparatus 102 and the management module 104 respectively shown in FIG. 1.

In some examples, the wireless communication apparatus 202 is to communicate with the wireless device using a wireless protocol and to transmit the indication using the same wireless protocol. For example, the wireless communication protocol is Wi-Fi, Bluetooth®, or Bluetooth Low Energy (BLE). Therefore, in an example. the wireless device communicates with the wireless communication apparatus using Wi-Fi, and the wireless communication apparatus 202 transmits the indication using Wi-Fi. Thus, for example, the same hardware may be used for both communication with the wireless device and transmission of the indication. In some examples, the wireless communication apparatus 202 is to transmit the indication using a predetermined Service Set Identifier (SSID). The SSID may be known and accessible by a device that receives transmission of the indication, such as for example another access point or another wireless device.

The controller 204 is to cause the wireless communication apparatus 202 to broadcast the message to one of another wireless device and another access point for the network. If the message is received by another access point, the other access point may be connected to the network (e.g. via a wired or wireless communication technology such as Ethernet, Wi-Fi® or Bluetooth®) and may therefore be able to forward the message to another device in or via the network. If the message is received by another wireless device, the other wireless device may be able to forward the indication via another network such as for example a cellular network. The other wireless device may in some examples be a dedicated diagnostic device that may be brought into proximity (e.g. Wi-Fi range) of the access point 200 (e.g. it may be brought into the RF neighborhood of the access point 200) in the event of a communication failure to receive the broadcast message.

In some examples, the message includes an identifier of the first access point. Therefore, the access point which is experiencing the loss of connection can be identified, or example by a management node to which the message is forwarded or which receives the report. In some examples, the message indicating that the first access point is in the maintenance mode comprises or indicates at least one of: an Ethernet status, a virtual private network status, a radio status, an Internet reachability status, a cellular signal status, and a specific error message. Thus, for example, the message may indicate the status of one or more functions of the access point 200.

The access point 200 also includes a backup power supply 206 to power the wireless communication apparatus 202 when a main power supply (not shown) for the access point 200 is unavailable. The main power supply may be external to the access point 200. Therefore, the wireless communication apparatus 202 can still transmit the message even when the main power supply is unavailable. In some examples, the backup power supply 206 is a battery. In some examples, the access point 200 may include a microcontroller unit (MCU) that receives power (either continuously or from the backup power supply 206 in the event of unavailability of the main power supply) and may cause the wireless communication apparatus to transmit or broadcast the message in the event of the loss of communication.

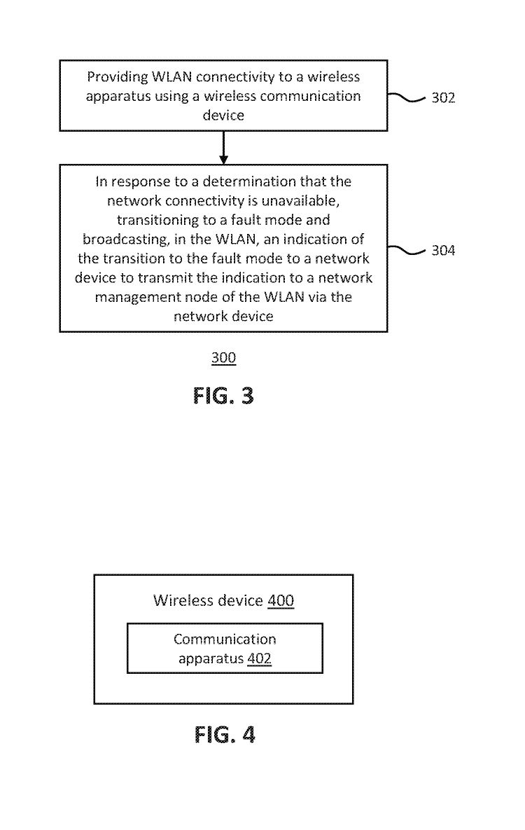

FIG. 3 is a flow chart of an example of a method 300, for example a method of providing WLAN connectivity. In some examples, the method 300 may be carried out by a node in a network such as an access point. The method comprises, in block 302, providing WLAN connectivity to a wireless apparatus using a wireless communication device. The network connectivity may for example enable the wireless apparatus to access a network through the wireless communication device. The method 300 also comprises, in block 304, in response to a determination that the network connectivity is unavailable, transitioning to a fault mode and broadcasting, in the WLAN, an indication of the transition to the fault mode to a network device to transmit the indication to a network management node of the WLAN via the network device.

Therefore, for example, in the event of a fault in hardware, a fault in cabling, or a loss of power, the indication of the transition to the fault mode may be broadcast or transmitted to an appropriate node or device, such as for example a network management node. In some examples, the indication may be broadcast using the same hardware that is used to provide the network connectivity, e.g., the wireless communication device. In some examples, the same wireless communication technology (e.g. Wi-Fi, Bluetooth or BLE) is used for both provision of network connectivity and transmission of the indication.

In some examples, the network device comprises one of another wireless apparatus and a network access point. Therefore, for example, broadcasting the indication comprises broadcasting the indication to one of another wireless apparatus and a network access point. The other wireless apparatus or the network access point may then in some examples forward the indication to the network management node.

In some examples, transmitting the indication comprises transmitting the indication in accordance with the same wireless specification that is used for providing the network connectivity to the wireless apparatus. The wireless specification may in some examples be an 802.11 specification (e.g. Wi-Fi), although any suitable wireless specification may be used.

FIG. 4 is a simplified schematic of an example of a wireless device 400. The wireless device 400 comprises communication apparatus 402 to receive a broadcast message from an access point in a Wireless Local Area Network (WLAN), wherein the broadcast message is received using a wireless protocol and the access point enables connectivity to the network using the wireless protocol, and wherein the broadcast message indicates that the access point has lost a connection to the network. The wireless device 400 is to transmit an indication that the access point has lost a connection to the network to a network management node. Therefore, in some examples, the network management node may take appropriate action in relation to the lost connection, such as for example informing a network manager or repairing the lost connection if possible. In some examples, transmitting the indication comprises forwarding the broadcast message to the network management node,

In some examples, therefore, the same hardware may be used by the access point to communicate with the wireless device 400 that is used to communicate with other wireless devices to provide access to the network. The device 400 may in some examples be a diagnostic device that is brought within wireless communication range (e.g. the RF neighborhood) of the access point, for example when the access point experiences the loss of connection to the network. In some examples, the wireless protocol comprises an 802.11 protocol such as Wi-Fi.

In some examples, the broadcast message and/or the indication identifies the access point. The broadcast message and/or indication may then be used to identify the particular access point that is experiencing the loss of connection. Therefore, in some examples, the network management node may receive the identification of the access point (e.g. in the forwarded broadcast message or along with the indication) and may for example use this information to locate the access point that is experiencing the lost connection to the network.

In some examples, the wireless device is to transmit the indication to the network management node using another network. The other network may be for example a wired or wireless network such as a cellular network.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A first access point for a wireless local area network (WLAN), the access point comprising:
a wireless communication apparatus to communicate with a wireless device to provide access to the network; and
a management module to:
determine a loss of connectivity to the network by the access point;
switch the first access point into a maintenance mode in response to determining the loss of connectivity to the network by the access point;
cause the wireless communication apparatus to broadcast a message in the WLAN indicating that the first access point is in the maintenance mode to cause a network device in a radio frequency (RF) neighborhood of the first access point to receive the message and report to a network management node of the WLAN that the first access point is in the maintenance mode.

2. The access point of claim 1, wherein the network device comprises one of a second access point and a wireless device.

3. The access point of claim 1, wherein the wireless protocol comprises one of a WI-Fi protocol and a Bluetooth Low Energy (BLE) protocol.

4. The access point of claim 1, wherein the wireless communication apparatus is to transmit the message using a predetermined Service Set Identifier (SSID).

5. The access point of claim 1, wherein the message indicating that the first access point is in the maintenance mode comprises at least one of: an Ethernet status, a virtual private network status, a radio status, an Internet reachability status, a cellular signal status, and a specific error message.

6. The access point of claim 1, wherein the message includes an identifier of the first access point.

7. The access point of claim 1, further comprising a backup power supply to power the wireless communication apparatus when a main power supply for the first access point is unavailable.

8. A method comprising:
providing Wireless Local Area Network (WLAN) connectivity to a wireless apparatus using a wireless communication device; and
in response to a determination that the network connectivity is unavailable:
transitioning to a fault mode; and
broadcasting, in the WLAN, an indication of the transition to the fault mode to a network device to transmit the fault information to a network management node of the WLAN via the network device.

9. The method of claim 8, wherein the network device comprises one of another wireless apparatus and a network access point.

10. The method of claim 8, wherein transmitting the indication comprises transmitting the indication in accordance with the same wireless specification that is used for providing the network connectivity to the wireless apparatus.

11. The method of claim 10, wherein broadcasting the indication comprises broadcasting the indication using the wireless communication device.

12. A wireless device comprising:
communication apparatus to receive a broadcast message from an access point in a Wireless Local Area Network (WLAN), wherein the broadcast message is received using a wireless protocol and the access point enables connectivity to the network using the wireless protocol, and wherein the broadcast message indicates that the access point has lost a connection to the network;
wherein the wireless device is to transmit an indication that the access point has lost a connection to the network to a network management node.

13. The wireless device of claim 12, wherein transmitting the indication comprises forwarding the broadcast message to the network management node.

14. The wireless device of claim 12, wherein the indication identifies the access point.

15. The wireless device of claim 12, wherein the wireless device is to transmit the indication to the network management node using another network.
